(19) United States
(12) Patent Application Publication
(10) Pub. No.: US 2023/0138736 A1
(43) Pub. Date: May 4, 2023

(54) CLUSTER FILE SYSTEM-BASED DATA BACKUP METHOD AND APPARATUS, AND READABLE STORAGE MEDIUM

(71) Applicant: INSPUR ELECTRONIC INFORMATION INDUSTRY CO., LTD., Jinan, Shandong (CN)

(72) Inventors: Bingheng YAN, Jinan, Shandong (CN); Hao FANG, Jinan, Shandong (CN)

(21) Appl. No.: 17/927,719

(22) PCT Filed: Jan. 25, 2021
(86) PCT No.: PCT/CN2021/073477

§ 371 Date: Nov. 24, 2022

(30) Foreign Application Priority Data
May 29, 2020 (CN) 202010471506.6

(51) Int. Cl. G06F 11/14; G06F 16/11; G06F 9/455

(52) U.S. Cl. CPC G06F 11/1451; G06F 11/1464; G06F 16/116; G06F 9/45558; G06F 2009/45595; G06F 2201/84

(57) ABSTRACT

A cluster file system-based data backup method includes: deploying the same storage area network for a production server and a backup server in advance; formatting the production server into a cluster file system according to the LUN provided by a storage system or a disk array based on the filename of a virtual disk of a virtual machine to be backed up and the data storage format of the virtual disk, reading from the cluster file system metadata information of the virtual machine to be backed up; according to the metadata information, the data backup type, the SCSI identification number of the LUN where the virtual machine to be backed up is located, and the filename of the virtual disk, determining the storage position on the LUN of data to be backed up, and backing up the data to be backed up that is read from the storage position.

### CROSS-REFERENCE TO RELATED APPLICATION

The present application claims the priority of the Chinese patent application filed on May 29, 2020 before the CNIPA, China National Intellectual Property Administration with the application number of 202010471506.6 and the title of “CLUSTER FILE SYSTEM-BASED DATA BACKUP METHOD AND APPARATUSDEVICE BASED ON CLUSTER FILE SYSTEM, AND READABLE STORAGE MEDIUM”, which is incorporated herein in its entirety by reference.

### FIELD

The present application relates to the technical field of virtual machine data resource backup, and in particular to a data backup method and a device based on a cluster file system, and a computer-readable storage medium.

### BACKGROUND

Data backup is the basis of disaster tolerance. By copying all or part of the data set from the hard disk or array of an application host to other storage media, it may effectively prevent data loss caused by system operation error or system failure, thereby ensuring data security. With the rapid development of cloud technology, the virtual machine data of a cloud platform also needs to be backed up.

In related art, local area network (LAN) backup or LAN-Free backup is generally used for virtual machine data backup. The LAN backup is to deploy a backup agent and a set of backup servers in the production system, and the data generated in the production system will be transmitted to the backup server through the backup agent. This solution occupies a large number of computing resources, storage and network resources of the production system, and is not applicable to data backup of a large amount of data. However, the LAN-Free solution is to conduct the backup directly through a data network from a data disk to a backup server, and does not need to occupy network resources of a service but needs to occupy computing resources. Occupying production server resources to conduct data backup not only requires high hardware requirements for a production server, but may even affect the normal operation of the production server.

In view of this, it is a technical problem to be solved by a person skilled in the art how to realize that backup data does not pass through a computing resource and a network resource of a production server in a data backup process.

### SUMMARY

The present application provides a data backup method and a device based on a cluster file system, and a computer-readable storage medium, and realizes the backup of virtual machine data on the basis of not occupying production server resources.

In order to solve the above technical problem, the present application provides the following technical solutions:

In one aspect, the embodiment of the present application provides a data backup method based on a cluster file system, including:

deploying a same storage area network for a production server and a backup server in advance; wherein the production server is formatted as the cluster file system according to a storage disk logical unit number provided by a storage system or a disk array so as to provide virtual storage resources for a cloud platform virtual machine;

reading metadata information about a virtual machine to be backed up from the cluster file system based on a file name of a virtual disk corresponding to the virtual machine to be backed up and a data storage format of the virtual disk; and

according to the metadata information, a data backup type, a small computer system interface identification number of a logical unit number where the virtual machine to be backed up is located, and the file name, determining a storage position of data to be backed up on the logical unit number, and backing up the data to be backed up read from the storage position; wherein the data backup type includes incremental data backup and full data backup.

In an embodiment of the present application, the according to the metadata information, a data backup type, a small computer system interface identification number of a logical unit number where the virtual machine to be backed up is located, and the file name, determining a storage position of data to be backed up on the logical unit number, and backing up the data to be backed up read from the storage position include:

under the condition that the virtual machine to be backed up is not a first data backup, determining the data backup type as the incremental data backup;

comparing the metadata information with metadata stored in the backup server to determine difference data and obtain a difference address of the difference data;

determining a starting position and a data length of the difference address in the virtual disk according to a data distribution manner of a data storage format;

positioning the storage position of the difference data on the logical unit number according to the small computer system interface identification number, the file name, the starting position, and the data length; and

backing up the difference data read from the storage position.

In an embodiment of the present application, the data storage format is a Qcow2 format, including a header, an L1 table, an L2 table, and a plurality of clusters; data of the virtual machine to be backed up is indexed to a target cluster where the difference data is stored via the L1 table and the L2 table, so as to be used for reading corresponding data from the target cluster according to the starting position and the data length.

In an embodiment of the present application, the according to the metadata information, a data backup type, a small computer system interface identification number of a logical unit number where the virtual machine to be backed up is located, and the file name, determining a storage position of data to be backed up on the logical unit number, and backing up the data to be backed up read from the storage position include:

under the condition that the virtual machine to be backed up is the first data backup, determining the data backup type as the full data backup;

determining the storage position of the data to be backed up on the logical unit number according to the small computer system interface identification number and the file name; and

backing up the metadata in the metadata information and the data to be backed up read from the storage position.

In an embodiment of the present application, after backing up the difference data read from the storage position, the method further includes:

under the condition that a data recovery request is received, sending an instruction to the production server to suspend or shut down a loaded virtual machine;

acquiring corresponding target difference data information according to a time point to be recovered carried in the data recovery request, wherein the target difference data includes a starting position, a data length, and data content of changed data; and

calling a pre-installed data parsing and reading tool to overwrite target data stored in a backup platform to the logical unit number according to the file name and the target difference data information;

wherein the data parsing and reading tool is configured to parse storage content of a file system on the logical unit number and assist the backup server in reading stored data.

In another aspect, the embodiment of the present application provides data backup device based on a cluster file system, including:

a system deployment module configured for deploying a production server and a backup server in a same storage area network in advance; wherein the production server is formatted as the cluster file system according to a storage disk logical unit number provided by a storage system or a disk array so as to provide virtual storage resources for a cloud platform virtual machine;

a metadata information reading module configured for reading metadata information about a virtual machine to be backed up from the cluster file system based on a file name of a virtual disk corresponding to the virtual machine to be backed up and a data storage format of the virtual disk; and

a data backup module configured for, according to the metadata information, a data backup type, a small computer system interface identification number of a logical unit number where the virtual machine to be backed up is located, and the file name, determining a storage position of data to be backed up on the logical unit number, and backing up the data to be backed up read from the storage position; wherein the data backup type includes incremental data backup and full data backup.

In an embodiment of the present application, the data backup module includes:

a backup-type determination sub-module configured for, under the condition that the virtual machine to be backed up is not a first data backup, determining the data backup type as the incremental data backup;

a difference address acquisition sub-module configured for comparing the metadata information with the metadata stored in the backup server to determine difference data and obtain a difference address of the difference data;

a storage data positioning information determination sub-module configured for determining a starting position and data length of the difference address in the virtual disk according to a data distribution manner of a data storage format;

a storage position positioning sub-module configured for positioning the storage position of the difference data on the logical unit number according to the small computer system interface identification number, the file name, the starting position, and the data length; and

a virtual data backup sub-module configured for backing up the difference data read from the storage position.

In an embodiment of the present application, further including a data recovery module, wherein the data recovery module includes:

a data-recovery-work preparation sub-module configured for, under the condition that a data recovery request is received, sending an instruction to the production server to suspend or shut down a loaded virtual machine;

a changed data determination sub-module configured for acquiring corresponding target difference data information according to a time point to be recovered carried in the data recovery request, wherein the target difference data includes a starting position, a data length, and data content of changed data; wherein the data parsing and reading tool is configured to parse storage content of a file system on the logical unit number and assist the backup server in reading stored data;

and a write data sub-module configured for calling a pre-installed data parsing and reading tool to overwrite target data stored in a backup platform to the logical unit number according to the file name and the target difference data information.

The embodiment of the present application further provides a data backup device based on a cluster file system, including a processor for implementing steps of the data backup method based on the cluster file system according to any one of the above embodiments when executing a computer program stored in memory.

The embodiment of the present application finally provides a computer-readable storage medium, storing a data backup program based on a cluster file system, wherein the data backup program based on the cluster file system, when executed by a processor, implements steps of the data backup method based on the cluster file system according to any one of the above embodiments.

The technical solution provided by the application has the advantages of: the production server and the backup server share the same storage area network, and there is no need to establish a local area network to interwork the network, and the two do not need to perform direct data interaction, and do not occupy the resources of the production server; the data of the cloud platform virtual machine is stored in the cluster file system obtained from formatting the production server based on the logical unit number (LUN) provided by the storage system or the disk array, without occupying the storage resources; the backup server reads the data from the cluster file system and then performs backup, and the whole process does not depend on the computing resources and storage resources of the production system, so as to realize the backup of the virtual machine data on the basis of not occupying the resources of the production server, and at the same time, without extending the relevant small computer system interface (SCSI) instruction to complete the backup of the data.

In addition, the embodiment of the present application also provides a corresponding implementation device and a computer-readable storage medium for the data backup method based on the cluster file system, further making the method more practical, and the device and computer-readable storage medium have corresponding advantages.

It should be understood that the above general description and the following detailed description are only illustrative and do not limit the present disclosure.

### BRIEF DESCRIPTION OF THE DRAWINGS

In order to illustrate the technical solutions of the embodiments of the present application or the related art more clearly, a brief description will be given below of the drawings necessary for the description of the embodiments or the related art. Apparently, the drawings in the following description are only some embodiments of the present application, and those of ordinary skill in the art may obtain other drawings based on these drawings without involving any inventive effort.

FIG. 1 is a schematic flow chart of a data backup method based on a cluster file system provided by the embodiments of the present application;

FIG. 2 is a schematic diagram of deployment of a backup server and production server provided by the embodiments of the present application;

FIG. 3 is a schematic diagram of a data storage format of a cluster file system provided by the embodiments of the present application;

FIG. 4 is a structure diagram of a specific implementation mode of a data backup device based on a cluster file system provided by the embodiments of the present application;

FIG. 5 is a structure diagram of another specific implementation mode of a data backup device based on a cluster file system provided by the embodiments of the present application; and

FIG. 6 is a structure diagram of yet another specific implementation mode of a data backup device based on a cluster file system provided by the embodiments of the present application.

### DETAILED DESCRIPTION

In order to enable those in the technical field to better understand the solution of the present application, the present application will be further described in detail in combination with the drawings and specific embodiments. Obviously, the described embodiments are only part of the embodiments of the present application, not all of them. Based on the embodiments of the present application, all other embodiments obtained by ordinary technicians in the art without creative work belong to the scope of the present application.

The terms “first”, “second”, “third” and “fourth” in the description and claims of the present application and the above drawings are used to distinguish different objects, not to describe a specific order. In addition, the terms “including” and “having” and any deformation thereof are intended to cover non-exclusive inclusion. For example, a process, method, system, product or device that contains a series of steps or units is not limited to the listed steps or units, but may include steps or units that are not listed.

After introducing the technical solution of the embodiment of the present application, various non limiting embodiments of the present application are described in detail below.

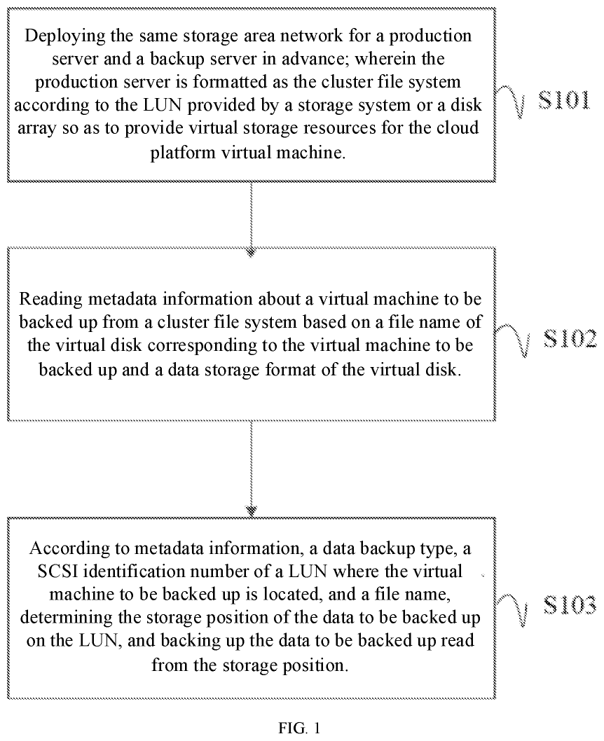

Referring first to FIG. 1, FIG. 1 is a schematic flow chart of a data backup method based on a cluster file system provided by the embodiments of the present application. The embodiment of the present application may include the following contents:

S101: deploying the same storage area network for a production server and a backup server in advance; wherein the production server is formatted as the cluster file system according to the LUN provided by a storage system or a disk array so as to provide virtual storage resources for the cloud platform virtual machine.

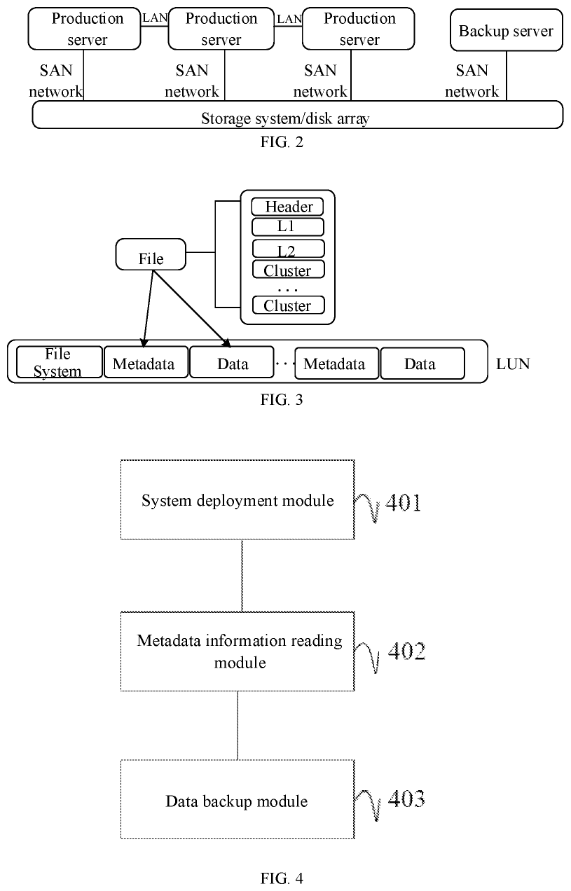

The technical solution of the present application is applied to the data backup of a cloud platform system based on the cluster file system, for example, is applicable to a cloud platform system of an OCFS2 file system, such as the data backup of Incloud Sphere and Incloud Rail platforms. The cloud platform system includes a backup server and a production server, and virtual machine data in the cloud platform system is backed up in the backup server. Prior to the normal operation of the cloud platform system, cloud management platform deployment and networking need to be performed. Since cloud platforms such as InCloud Sphere and Incloud Rail platforms use a cluster file system and rely on IP-SAN or FC-SAN networking environment, a backup data platform is installed for the backup server after cloud management platform deployment and networking are completed. As shown in FIG. 2, the cloud platform networking environment may include that:

a production server and a backup server share the same storage area network (SAN). The storage area network networking may be a fibre channel-storage area network (FC-SAN) or an internet protocol-storage area network (IP-SAN), and that is not limited in any way in the present application. The backup server and the production server do not need to establish a local area network (LAN) to interwork the network. The production server conducts formatting and forms an OCFS2 cluster file system according to a storage disk logical unit number provided by a storage system or a disk array, and provides a virtual storage resource for the cloud platform. In the storage area network, LUN is the smallest storage unit in a storage system and may be referred to as a storage disk.

In addition, in order to implement the data backup function, the backup server also needs to preinstall a data parsing and reading tool for parsing the file system storage contents on the LUN and assisting the backup server to read the stored data, and the data parsing and reading tool may be, for example, a Storage Agent package. The Storage Agent package is one set of command combinations to parse the file system storage contents on the LUN and assist the backup server in reading the stored data, and does not need to interact with the production server.

S102: reading metadata information about a virtual machine to be backed up from a cluster file system based on a file name of the virtual disk corresponding to the virtual machine to be backed up and a data storage format of the virtual disk.

When the cloud platform system is in a normal working state after the deployment is completed, and when a virtual machine data backup request is received, a virtual disk corresponding to the virtual machine to be backed up and a space capacity value occupied by it, the data storage format of the virtual disk, and a SCSI identification number of a LUN where the virtual machine to be backed up is located may be acquired from the backup server. The virtual machine to be backed up is the virtual machine needing data backup in the backup request. The SCSI identification number serves as a unique identification of the storage disk, and the LUN may be addressed and positioned based on the SCSI identification number of the LUN where the virtual machine to be backed up is located. In the production server, a file system is created based on the storage disk LUN provided by the storage array, and meanwhile, the storage resource is provided for the virtual machine of the cloud platform by using the file provided by the file system. A file is also commonly referred to as a virtual disk, and the data storage format of the virtual disk is, for example, the Qcow2 format. The virtual disk stores data resources based on the Qcow2 format, and it may also be the RAW format. The RAW format is bare data with no storage format and may be read directly. Different data storage formats correspond to different storage data distributions. When a virtual disk of a cluster file system stores data, including metadata and data, the metadata records the updated information, the storage address, etc. of the stored data.

S103: according to metadata information, a data backup type, a SCSI identification number of a LUN where the virtual machine to be backed up is located, and a file name, determining the storage position of the data to be backed up on the LUN, and backing up the data to be backed up read from the storage position.

After reading the metadata information in S103, the changed data may be determined by comparing with the metadata information stored in the backup server. It is clear that, under the condition that the metadata is not present in the backup server, the virtual machine to be backed up is the first data backup. The types of data backup include incremental data backup and full data backup. The incremental data backup is to back up the data changed in two adjacent backup processes, while the full data backup is to back up all the data in each backup. The user may select according to actual requirements. According to one aspect of the present application, the full data backup may be selected when the virtual machine is backing up data for the first time, and the incremental data backup may be selected when backing up data is performed for the n^{th} time. The LUN may be positioned based on the SCSI identification number of the LUN where the virtual machine to be backed up is located, the virtual disk on the LUN may be determined based on the file name, the corresponding data may be read from the virtual disk based on the metadata information and the data backup type, the Storage Agent package of the backup server may be called to read and parse the data on the LUN, and then the read data is backed up in the backup server.

In the technical solution provided by an embodiment of the present application, the production server and the backup server share the same storage area network, and there is no need to establish a local area network to interwork the network, and the two do not need to perform direct data interaction, and do not occupy the resources of the production server; the data of the cloud platform virtual machine is stored in the cluster file system obtained from formatting the production server based on the LUN provided by the storage system or the disk array, without occupying the storage resources of the production server; the backup server reads the data from the cluster file system and then performs backup, and the whole process does not depend on the computing resources and storage resources of the production system, so as to realize the backup of the virtual machine data on the basis of not occupying the resources of the production server, and at the same time, without extending the relevant SCSI instruction to complete the backup of the data.

It needs to be noted that there is no strict sequential execution order among the steps in the present application, and these steps may be executed at the same time as long as the logical order is satisfied, or may be executed in a certain pre-set order. FIG. 1 is a schematic way, and does not represent only such an execution order.

In the above-mentioned embodiments, there is no limitation on how to execute step

S103. An implementation mode is given in the present embodiment, which may include the following steps.

A1: under the condition that the virtual machine to be backed up is not the first data backup, determining the data backup type as the incremental data backup.

A2: comparing the metadata information with metadata stored in the backup server to determine the difference data and obtain a difference address of the difference data. The difference data is the data changed in two adjacent backup processes, and the difference address is the storage address of the changed data.

A3: determining the starting position and data length of the difference address in the virtual disk according to the data distribution manner of the data storage format.

A4: positioning the storage position of the difference data on the LUN according to the SCSI identification number, the file name, the starting position, and the data length.

A5: backing up the difference data read from the storage position.

The present application also provides another implementation mode, in parallel with the above. Therefore, as another alternative implementation mode, S103 may include steps as follows.

B1: under the condition that the virtual machine to be backed up is the first data backup, determining the data backup type as the full data backup.

B2: determining the storage position of the data to be backed up on LUN according to the SCSI identification number and the file name.

B3: backing up the metadata in the metadata information and the data to be backed up read from the storage position.

Under the condition that the virtual machine is the first data backup, the metadata needs to be backed up in the backup server as a whole. Under the condition that the data backup type is the full data backup, it is not necessary to pay attention to the difference data, and all the virtual machine data at the current backup moment are read and processed to be backed up in the backup server.

The above proves that the embodiment of the present application determines a corresponding data backup type with regard to the backup times of a virtual machine. In the subsequent backup process, only incremental data is backed up to improve the backup efficiency, and the storage space utilization rate of a backup server is higher.

It may be understood that the virtual machine needs to roll back to a certain moment based on running a task, and correspondingly, the data at this moment needs to be recovered. That is to say, the virtual machine is reset at a target moment, and then data recovery needs to be performed based on the backup server. The data recovery process may include the following steps.

C1: under the condition that a data recovery request is received, sending an instruction to the production server to suspend or shut down the loaded virtual machine. In order to ensure the consistency of the data, the virtual machine in the production server needs to be suspended or shut down to do data recovery.

C2: acquiring the corresponding target difference data information according to a time point to be recovered carried in the data recovery request, the target difference data including a starting position, a data length, and data content of the changed data. Among them, the target difference data is the data that is changed by comparing the time point to be recovered with the time point at the current moment.

C3: calling a pre-installed data parsing and reading tool to overwrite the target data stored in the backup platform to the LUN according to the file name and the target difference data information. The data parsing and reading tool is used for parsing the storage content of the file system on the LUN and assisting the backup server in reading the stored data. Under the condition that the Storage Agent tool is called, the data stored in the backup platform is overwritten on the LUN at a corresponding position according to the name of the file on the virtual disk, the starting position, and the length.

C4: the virtual disk of the virtual machine may obtain the original data at the time point to be recovered recorded by the backup platform.

The above proves that the data recovery process of the embodiment of the present application likewise does not occupy LAN and production server computing and network resources.

In order to make the technical solutions of the present application clearer to a person skilled in the art, the present application also provides an illustration by taking an OCFS2 cluster file system of which the data storage format of a virtual disk is a Qcow2 format as an example to describe the whole data backup process, including the following contents.

The overall data storage layout format of a virtual disk storing data resources in the Qcow2 format is shown in FIG. 3. A single virtual disk, namely, a file of a file system, is composed of two parts, namely, metadata and data. Data in the file is retrieved from the file system. Firstly, metadata information needs to be inquired according to the name of the file, and a data storage position and a data length are retrieved according to the metadata information; finally, the corresponding data may be obtained from the storage position and the length on the LUN. The Qcow2 format is one fixed data format that stores and retrieves data by a secondary index table. A header, an L1 table, an L2 table, and multiple clusters are included. That is to say, in conjunction with FIG. 3, the content actually stored in the data area is in a Qcow2 format, and the Qcow2 format is composed of basic data structures such as a header, L1 table, L2 table, a Cluster, etc. The content stored in the Cluster (data storage position) may be indexed through L1 table and L2 table. The content stored in the virtual machine is actually stored in the Cluster, and the virtual machine data to be backed up is indexed to the target cluster where the difference data is stored via L1 table and L2 table, so as to read the corresponding data from the target cluster according to the starting position and the data length. Through the above-mentioned basic principle, the content in the virtual machine may be retrieved via the file organization, namely, the Qcow2 format, of the file system from the LUN directly through the file name, so as to achieve the purpose of backing up the data in the virtual machine.

The whole backup process is established according to the above content, and the process is as follows.

On a backup platform according to a virtual machine needing to be backed up, a virtual disk corresponding to the virtual machine, a capacity size, and a virtual disk format are acquired, and at the same time, the SCSI ID of a LUN where the virtual machine is located is acquired.

A command provided by a Storage Agent tool installed on the backup server is called to read the data content of the virtual disk according to the name of an incoming file, and according to a retrieval method corresponding to a data storage format, only reading the metadata area content of the Qcow2 so as to acquire the metadata information about the virtual disk file.

The difference information of two metadata is compared: during the first backup, the metadata area is stored in the backup server. On the second backup, the difference address from the last two Qcow2 metadata is checked by comparing with the metadata stored last time.

The Storage Agent command is called to send in the file name of the virtual disk, the storage position on the LUN is retrieved according to the starting position and the data length of the file, and a basic file read-write interface is used in the corresponding storage position to read the corresponding content and store the difference data in the backup server.

The above proves that the embodiment of the present application realizes the backup of virtual machine data on the basis of not occupying production server resources.

An embodiment of the present application also provides a corresponding device for a data backup method based on a cluster file system, further making the method more practical. The device may be respectively described from the perspective of functional modules and the perspective of hardware. A data backup device based on a cluster file system provided by an embodiment of the present application is described below. The data backup device based on a cluster file system described below and the data backup method based on a cluster file system described above may be referred to correspondingly.

Based on the perspective of functional modules, reference is made to FIG. 4, which is a structure diagram of a specific implementation mode of a data backup device based on a cluster file system provided by an embodiment of the present application. The device may include:

a system deployment module 401 for deploying a production server and a backup server in the same storage area network in advance; wherein the production server is formatted as the cluster file system according to the LUN provided by a storage system or a disk array so as to provide virtual storage resources for the cloud platform virtual machine;

a metadata information reading module 402 for reading metadata information about a virtual machine to be backed up from a cluster file system based on a file name of the virtual disk corresponding to the virtual machine to be backed up and a data storage format of the virtual disk;

a data backup module 403 for, according to metadata information, a data backup type, a SCSI identification number of a LUN where the virtual machine to be backed up is located, and a file name, determining the storage position of the data to be backed up on the LUN, and backing up the data to be backed up read from the storage position; wherein the data backup type includes incremental data backup and full data backup.

According to one aspect of the present application, in some implementation modes of the present embodiment, the data backup module 403 may include:

a backup-type determination sub-module, wherein under the condition that the virtual machine to be backed up is not the first data backup, determining the data backup type as the incremental data backup;

a difference address acquisition sub-module for comparing the metadata information with the metadata stored in the backup server to determine difference data and obtain a difference address of the difference data;

a storage data positioning information determination sub-module for determining the starting position and data length of the difference address in the virtual disk according to the data distribution manner of the data storage format;

a storage position positioning sub-module for positioning the storage position of the difference data on the LUN according to the SCSI identification number, file name, starting position, and data length;

and a virtual data backup sub-module for backing up the difference data read from a storage position.

In some other implementation modes of this embodiment, the data backup module 403 may further include:

a second backup-type determining sub-module for, wherein under the condition that the virtual machine to be backed up is the first data backup, determining the data backup type as the full data backup;

a storage position determination sub-module for determining the storage position of data to be backed up on LUN according to the SCSI identification number and file name;

and a backup sub-module for backing up the metadata in the metadata information and the data to be backed up read from the storage position.

According to one aspect of the present application, in some other implementation modes of the present embodiment, referring to FIG. 5, the device may further include, for example, a data recovery module 404. The data recovery module 404 may include:

a data-recovery-work preparation sub-module for, under the condition that a data recovery request is received, sending an instruction to the production server to suspend or shut down the loaded virtual machine;

a changed data determination sub-module for acquiring the corresponding target difference data information according to a time point to be recovered carried in the data recovery request, the target difference data including a starting position, a data length, and data content of the changed data; a data parsing and reading tool for parsing the storage content of the file system on the LUN and assisting the backup server in reading the stored data;

and a write data sub-module for calling a pre-installed data parsing and reading tool to overwrite the target data stored in the backup platform to the LUN according to the file name and the target difference data information.

The functions of each functional module of a data backup device based on a cluster file system according to an embodiment of the present application may be specifically implemented according to the method in the above-mentioned method embodiment, and the specific implementation process may be referred to the relevant description of the above-mentioned method embodiment and thus will not be described in detail herein.

The above proves that the embodiment of the present application realizes the backup of virtual machine data on the basis of not occupying production server resources.

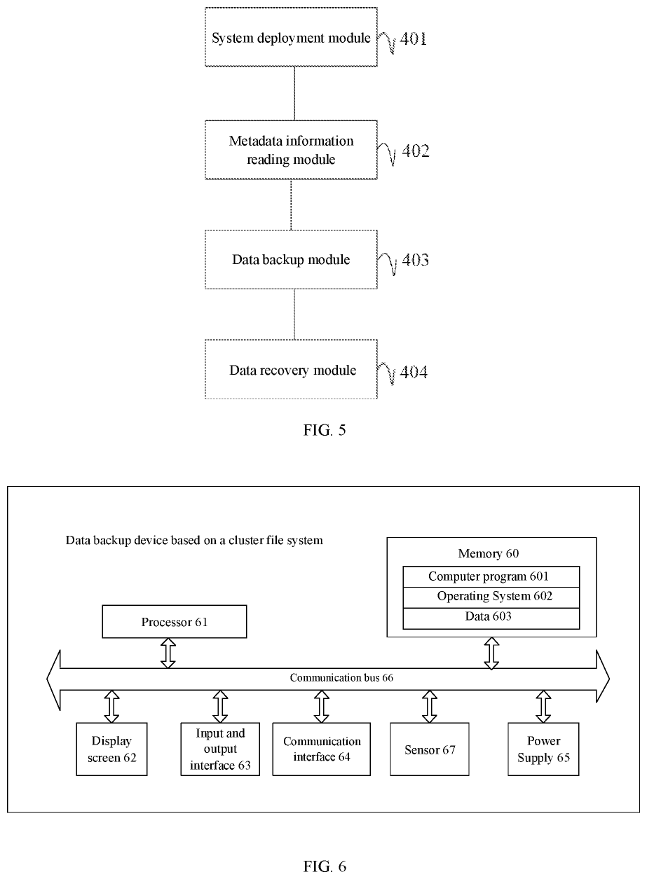

The above-mentioned data backup device based on a cluster file system is described from the perspective of functional modules; furthermore, the present application also provides a data backup device based on a cluster file system, which is described from the perspective of hardware. FIG. 6 is a structure diagram of another data backup device based on a cluster file system provided by an embodiment of the present application. As shown in FIG. 6, the device may include a memory 60 for storing a computer program; and

a processor 61 for implementing the steps of a data backup method based on a cluster file system as mentioned in any of the above embodiments when executing a computer program.

Among other things, the processor 61 may include one or more processing cores, such as a 4-core processor, an 8-core processor, etc. The processor 61 may be implemented in at least one hardware form of Digital Signal Processing (DSP), Field-Programmable Gate Array (FPGA), Programmable Logic Array (PLA). The processor 61 may also include a main processor and a coprocessor. The main processor is a processor for processing data in a wake-up state, and is also called a Central Processing Unit (CPU); the coprocessor is a low-power processor for processing data in a standby state. In some embodiments, the processor 61 may be integrated with a Graphics Processing Unit (GPU), the GPU being responsible for rendering and drawing the content that the display screen needs to display. In some embodiments, the processor 61 may also include an Artificial Intelligence (AI) processor for processing computing operations related to machine learning.

The memory 60 may include one or more computer-readable storage media, which may be non-transitory. Memory 60 may also include high-speed random access memory, as well as non-volatile memory, such as one or more magnetic disk storage apparatuses and flash memory storage apparatuses. In the present embodiment, the memory 60 is at least used for storing a computer program 601 which, after being loaded and executed by the processor 61, is capable of implementing the relevant steps of the data backup method based on a cluster file system as disclosed in any of the preceding embodiments. In addition, the resources stored in the memory 60 may also include an operating system 602, data 603, etc. and the storage may be transient storage or permanent storage. Among other things, operating system 602 may include Windows, Unix, Linux, etc. The data 603 may include, but is not limited to, the corresponding data in the process of data backup based on a cluster file system, etc.

In some embodiments, the data backup device based on a cluster file system may further include a display screen 62, an input and output interface 63, a communication interface 64, a power supply 65, and a communication bus 66.

It could be understood by those skilled in the art that the structure shown in FIG. 6 does not constitute a limitation on the data backup device based on a cluster file system, and may include more or fewer assemblies than those shown, e.g., a sensor 67.

The functions of each functional module of a data backup device based on a cluster file system according to an embodiment of the present application may be specifically implemented according to the method in the above-mentioned method embodiment, and the specific implementation process may be referred to the relevant description of the above-mentioned method embodiment and thus will not be described in detail herein.

The above proves that the embodiment of the present application realizes the backup of virtual machine data on the basis of not occupying production server resources.

It could be understood that under the condition that the data backup method based on the cluster file system of the above embodiment is implemented in the form of a software functional unit and sold or used as a stand-alone product, it may be stored on one computer-readable storage medium. Based on such an understanding, the technical solutions of the present application, either substantively or in any part contributing to the prior art, or with all or part of the technical solutions, may be embodied in the form of a software product stored in one storage medium for executing all or part of the steps of the method of various embodiments of the present application. The storage medium includes a USB flash disk, mobile hard disk drive, Read-Only Memory (ROM), Random Access Memory (RAM), electrically erasable programmable ROM, registers, hard disk, removable magnetic disk, CD-ROM, diskette, or optical disk and like media that may store a program code.

Based thereon, an embodiment of the present application also provides a computer-readable storage medium storing a data backup program based on a cluster file system that, when executed by a processor, performs the steps of the data backup method based on the cluster file system as described in any of the embodiments above.

The functions of the functional modules of the computer-readable storage medium according to the embodiments of the present application may be specifically implemented according to the methods in the above-mentioned method embodiments, and the specific implementation process may be referred to the relevant description of the above-mentioned method embodiments and thus will not be described in detail herein.

The above proves that the embodiment of the present application realizes the backup of virtual machine data on the basis of not occupying production server resources.

In this specification, each embodiment is described in a progressive manner. Each embodiment focuses on the differences with other embodiments. The same or similar parts of each embodiment may be referred to each other. For the device disclosed in the embodiment, since it corresponds to the method disclosed in the embodiment, the description is relatively simple. Please refer to the description of the method section for details.

Professionals may further realize that the units and algorithm steps of each example described in combination with the embodiments disclosed herein may be implemented in electronic hardware, computer software, or a combination of the two. In order to clearly explain the interchangeability of hardware and software, the composition and steps of each example have been generally described in the above description according to their functions. Whether these functions are implemented in hardware or software depends on the specific application and design constraints of the technical solution. Professionals and technicians may use different methods to realize the described functions for each specific application, but such implementation should not be considered beyond the scope of the invention.

The data backup method and device based on the cluster file system, and the computer readable storage medium provided in the present application are described in detail above. In this paper, specific examples are used to explain the principle and implementation mode of the invention. The above examples are only used to help understand the method and core idea of the invention. It should be pointed out that for ordinary technicians in the technical field, on the premise of not departing from the principle of the present application, a number of improvements and modifications may be made to the application, and these improvements and modifications also fall within the protection scope of the claims of the present application.

1. A data backup method based on a cluster file system, comprising:
deploying a same storage area network for a production server and a backup server in advance; wherein the production server is formatted as the cluster file system according to a storage disk logical unit number provided by a storage system or a disk array so as to provide virtual storage resources for a cloud platform virtual machine;
reading metadata information about a virtual machine to be backed up from the cluster file system based on a file name of a virtual disk corresponding to the virtual machine to be backed up and a data storage format of the virtual disk; and
according to the metadata information, a data backup type, a small computer system interface identification number of a logical unit number where the virtual machine to be backed up is located, and the file name, determining a storage position of data to be backed up on the logical unit number, and backing up the data to be backed up read from the storage position;
wherein the data backup type comprises incremental data backup and full data backup.

2. The data backup method based on the cluster file system according to claim 1, wherein the according to the metadata information, a data backup type, a small computer system interface identification number of a logical unit number where the virtual machine to be backed up is located, and the file name, determining a storage position of data to be backed up on the logical unit number, and backing up the data to be backed up read from the storage position comprise:
under the condition that the virtual machine to be backed up is not a first data backup, determining the data backup type as the incremental data backup;
comparing the metadata information with metadata stored in the backup server to determine difference data and obtain a difference address of the difference data;
determining a starting position and a data length of the difference address in the virtual disk according to a data distribution manner of a data storage format;
positioning the storage position of the difference data on the logical unit number according to the small computer system interface identification number, the file name, the starting position, and the data length; and
backing up the difference data read from the storage position.

3. The data backup method based on the cluster file system according to claim 2, wherein the data storage format is a Qcow2 format, comprising a header, an L1 table, an L2 table, and a plurality of clusters; data of the virtual machine to be backed up is indexed to a target cluster where the difference data is stored via the L1 table and the L2 table, so as to be used for reading corresponding data from the target cluster according to the starting position and the data length.

4. The data backup method based on the cluster file system according to claim 1, wherein the according to the metadata information, a data backup type, a small computer system interface identification number of a logical unit number where the virtual machine to be backed up is located, and the file name, determining a storage position of data to be backed up on the logical unit number, and backing up the data to be backed up read from the storage position comprise:
under the condition that the virtual machine to be backed up is the first data backup, determining the data backup type as the full data backup;
determining the storage position of the data to be backed up on the logical unit number according to the small computer system interface identification number and the file name; and
backing up the metadata in the metadata information and the data to be backed up read from the storage position.

5. The data backup method based on the cluster file system according to claim 1, wherein after backing up the difference data read from the storage position, the method further comprises:
under the condition that a data recovery request is received, sending an instruction to the production server to suspend or shut down a loaded virtual machine;
acquiring corresponding target difference data information according to a time point to be recovered carried in the data recovery request, wherein the target difference data information comprises a starting position, a data length, and data content of changed data; and
calling a pre-installed data parsing and reading tool to overwrite target data stored in a backup platform to the logical unit number according to the file name and the target difference data information;
wherein the data parsing and reading tool is configured to parse storage content of a file system on the logical unit number and assist the backup server in reading stored data.

6. (canceled)

7. (canceled)

8. (canceled)

9. A data backup device based on a cluster file system, comprising a processor; and a memory having processor-executable computer program stored thereon, when executed by the processor, cause the processor to:
deploy a same storage area network for a production server and a backup server in advance; wherein the production server is formatted as the cluster file system according to a storage disk logical unit number provided by a storage system or a disk array so as to provide virtual storage resources for a cloud platform virtual machine;
read metadata information about a virtual machine to be backed up from the cluster file system based on a file name of a virtual disk corresponding to the virtual machine to be backed up and a data storage format of the virtual disk; and
according to the metadata information, a data backup type, a small computer system interface identification number of a logical unit number where the virtual machine to be backed up is located, and the file name, determine a storage position of data to be backed up on the logical unit number, and back up the data to be backed up read from the storage position;
wherein the data backup type comprises incremental data backup and full data backup.

10. A computer-readable storage medium, storing a data backup computer program thereon, when executed by a processor, causes the processor to:
deploy a same storage area network for a production server and a backup server in advance; wherein the production server is formatted as the cluster file system according to a storage disk logical unit number provided by a storage system or a disk array so as to provide virtual storage resources for a cloud platform virtual machine;
read metadata information about a virtual machine to be backed up from the cluster file system based on a file name of a virtual disk corresponding to the virtual machine to be backed up and a data storage format of the virtual disk; and
according to the metadata information, a data backup type, a small computer system interface identification number of a logical unit number where the virtual machine to be backed up is located, and the file name, determine a storage position of data to be backed up on the logical unit number, and back up the data to be backed up read from the storage position; wherein the data backup type comprises incremental data backup and full data backup.

11. The data backup method based on the cluster file system according to claim 4, wherein under the condition that the metadata is not present in the backup server, the virtual machine to be backed up is the first data backup.

12. The data backup device based on the cluster file system according to claim 9, wherein the operation of according to the metadata information, a data backup type, a small computer system interface identification number of a logical unit number where the virtual machine to be backed up is located, and the file name, determine a storage position of data to be backed up on the logical unit number, and back up the data to be backed up read from the storage position comprises:
under the condition that the virtual machine to be backed up is not a first data backup, determining the data backup type as the incremental data backup;
comparing the metadata information with metadata stored in the backup server to determine difference data and obtain a difference address of the difference data;
determining a starting position and a data length of the difference address in the virtual disk according to a data distribution manner of a data storage format;
positioning the storage position of the difference data on the logical unit number according to the small computer system interface identification number, the file name, the starting position, and the data length; and
backing up the difference data read from the storage position.

13. The data backup device based on the cluster file system according to claim 12, wherein the data storage format is a Qcow2 format, comprising a header, an L1 table, an L2 table, and a plurality of clusters; data of the virtual machine to be backed up is indexed to a target cluster where the difference data is stored via the L1 table and the L2 table, so as to be used for reading corresponding data from the target cluster according to the starting position and the data length.

14. The data backup device based on the cluster file system according to claim 9, wherein the operation of according to the metadata information, a data backup type, a small computer system interface identification number of a logical unit number where the virtual machine to be backed up is located, and the file name, determine a storage position of data to be backed up on the logical unit number, and back up the data to be backed up read from the storage position comprises:
under the condition that the virtual machine to be backed up is the first data backup, determining the data backup type as the full data backup;
determining the storage position of the data to be backed up on the logical unit number according to the small computer system interface identification number and the file name; and
backing up the metadata in the metadata information and the data to be backed up read from the storage position.

15. The data backup device based on the cluster file system according to claim 14, wherein under the condition that the metadata is not present in the backup server, the virtual machine to be backed up is the first data backup.

16. The data backup device based on the cluster file system according to claim 9, wherein after backing up the difference data read from the storage position, the operations further comprise:
under the condition that a data recovery request is received, sending an instruction to the production server to suspend or shut down a loaded virtual machine;
acquiring corresponding target difference data information according to a time point to be recovered carried in the data recovery request, wherein the target difference data information comprises a starting position, a data length, and data content of changed data; and
calling a pre-installed data parsing and reading tool to overwrite target data stored in a backup platform to the logical unit number according to the file name and the target difference data information.

17. The data backup device based on the cluster file system according to claim 16, wherein the data parsing and reading tool is configured to parse storage content of a file system on the logical unit number and assist the backup server in reading stored data.

18. The computer-readable storage medium according to claim 10, wherein the operation of according to the metadata information, a data backup type, a small computer system interface identification number of a logical unit number where the virtual machine to be backed up is located, and the file name, determine a storage position of data to be backed up on the logical unit number, and back up the data to be backed up read from the storage position comprises:
under the condition that the virtual machine to be backed up is not a first data backup, determining the data backup type as the incremental data backup;
comparing the metadata information with metadata stored in the backup server to determine difference data and obtain a difference address of the difference data;
determining a starting position and a data length of the difference address in the virtual disk according to a data distribution manner of a data storage format;
positioning the storage position of the difference data on the logical unit number according to the small computer system interface identification number, the file name, the starting position, and the data length; and
backing up the difference data read from the storage position.

19. The computer-readable storage medium according to claim 18, wherein the data storage format is a Qcow2 format, comprising a header, an L1 table, an L2 table, and a plurality of clusters; data of the virtual machine to be backed up is indexed to a target cluster where the difference data is stored via the L1 table and the L2 table, so as to be used for reading corresponding data from the target cluster according to the starting position and the data length.

20. The computer-readable storage medium according to claim 10, wherein the operation of according to the metadata information, a data backup type, a small computer system interface identification number of a logical unit number where the virtual machine to be backed up is located, and the file name, determine a storage position of data to be backed up on the logical unit number, and back up the data to be backed up read from the storage position comprises:
under the condition that the virtual machine to be backed up is the first data backup, determining the data backup type as the full data backup;
determining the storage position of the data to be backed up on the logical unit number according to the small computer system interface identification number and the file name; and
backing up the metadata in the metadata information and the data to be backed up read from the storage position.

21. The computer-readable storage medium according to claim 20, wherein under the condition that the metadata is not present in the backup server, the virtual machine to be backed up is the first data backup.

22. The computer-readable storage medium according to claim 10, wherein after backing up the difference data read from the storage position, the operations further comprise:
under the condition that a data recovery request is received, sending an instruction to the production server to suspend or shut down a loaded virtual machine;
acquiring corresponding target difference data information according to a time point to be recovered carried in the data recovery request, wherein the target difference data information comprises a starting position, a data length, and data content of changed data; and
calling a pre-installed data parsing and reading tool to overwrite target data stored in a backup platform to the logical unit number according to the file name and the target difference data information.

23. The computer-readable storage medium according to claim 22, wherein the data parsing and reading tool is configured to parse storage content of a file system on the logical unit number and assist the backup server in reading stored data.
